(19) United States
(12) Patent Application Publication
(10) Pub. No.: US 2019/0061645 A1
(43) Pub. Date: Feb. 28, 2019

(54) DENT PROTECTION ASSEMBLY

(71) Applicant: Yvonne Green, Monrovia, CA (US)

(72) Inventor: Yvonne Green, Monrovia, CA (US)

(21) Appl. No.: 15/692,476

(22) Filed: Aug. 31, 2017

(51) Int. Cl. B60R 13/04; B60J 11/06

(52) U.S. Cl. CPC B60R 13/04; B60J 11/06

(57) ABSTRACT

A dent protection assembly for protecting a vehicle door from dents includes a cushion that is selectively positioned on an outside surface of a vehicle door. The cushion is comprised of a deformable material to inhibit the outside surface of the vehicle door from being dented. A plurality of magnets is provided and each of the magnets is positioned within the cushion. Each of the magnets magnetically engages the outside surface of the vehicle door when the cushion is positioned on the outside surface.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR Oreg. JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to protection devices and more particularly pertains to a new protection device for protecting a vehicle door from dents.

### BRIEF SUMMARY OF THE INVENTION

An embodiment of the disclosure meets the needs presented above by generally comprising a cushion that is selectively positioned on an outside surface of a vehicle door. The cushion is comprised of a deformable material to inhibit the outside surface of the vehicle door from being dented. A plurality of magnets is provided and each of the magnets is positioned within the cushion. Each of the magnets magnetically engages the outside surface of the vehicle door when the cushion is positioned on the outside surface.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a dent protection assembly according to an embodiment of the disclosure.

FIG. 2 is a top phantom view of an embodiment of the disclosure.

FIG. 3 is a bottom phantom view of an embodiment of the disclosure.

FIG. 4 is a cross sectional view taken along line 4-4 of FIG. 2 of an embodiment of the disclosure.

FIG. 5 is a perspective in-use view of an embodiment of the disclosure.

### DETAILED DESCRIPTION OF THE INVENTION

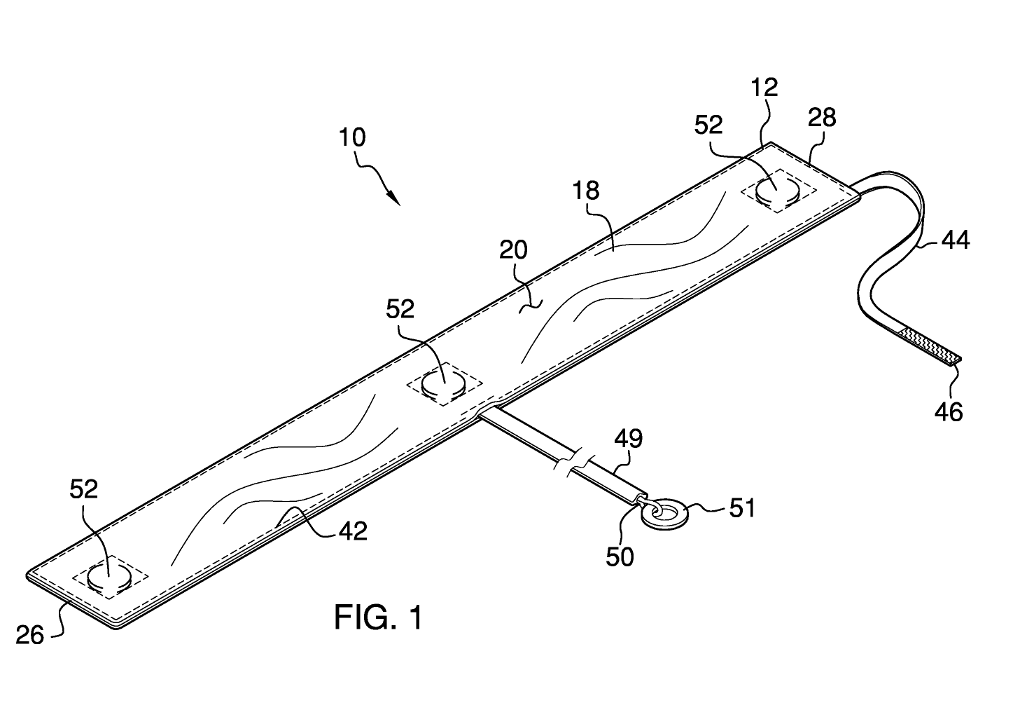

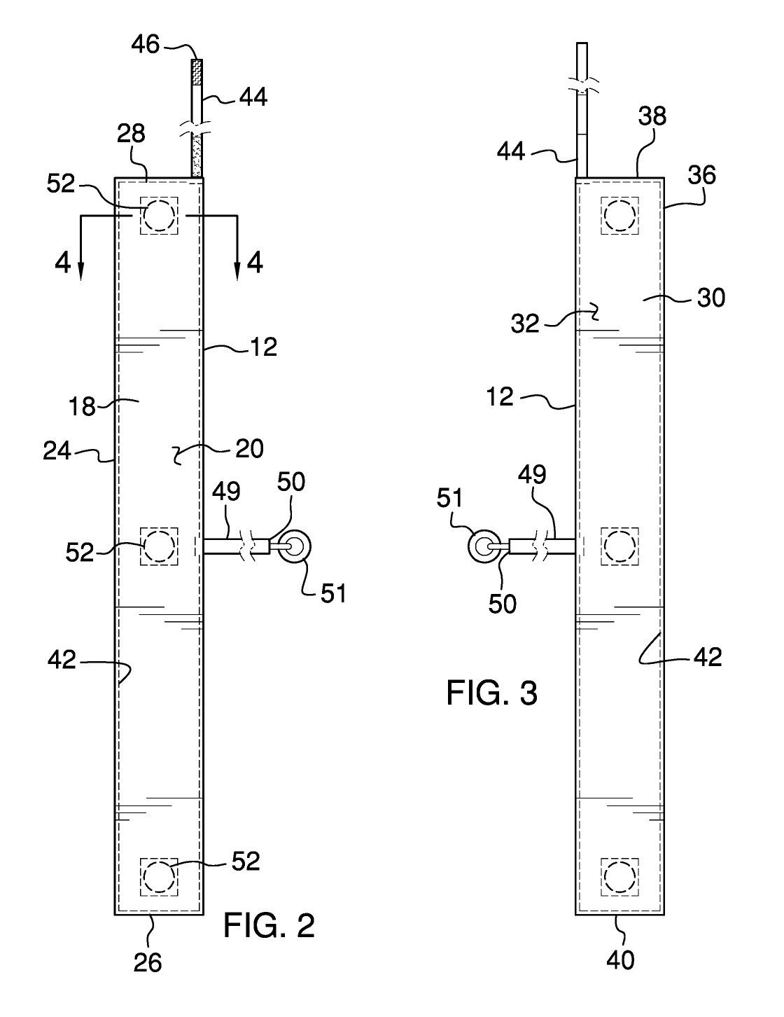

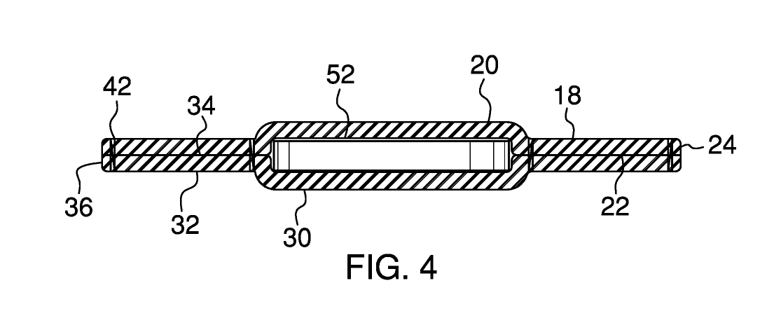

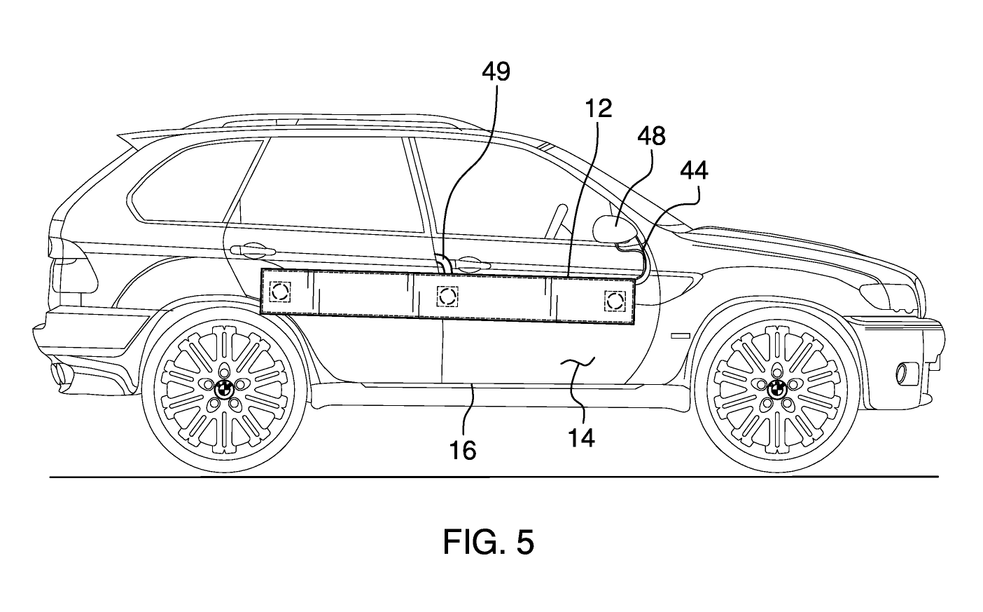

With reference now to the drawings, and in particular to FIGS. 1 through 5 thereof, a new protection device embodying the principles and concepts of an embodiment of the disclosure and generally designated by the reference numeral 10 will be described.

As best illustrated in FIGS. 1 through 5, the dent protection assembly 10 generally comprises a cushion 12 that may be positioned on an outside surface 14 of a vehicle door 16. The cushion 12 is comprised of a deformable material to inhibit the outside surface 14 of the vehicle door 16 from being dented. In this way the cushion 12 protects the vehicle door 16 from dings when the vehicle is positioned in a public parking area. Moreover, the vehicle may be a passenger vehicle or the like.

The cushion 12 comprises a first panel 18 that as a first surface 20, a second surface 22 and a perimeter edge 24 extending therebetween. The perimeter edge 24 has a first side 26 and a second side 28 and the first panel 18 is elongated between the first side 26 and the second side 28. The first surface 20 abuts the outside surface 14 of the vehicle door 16 when the cushion 12 is positioned on the vehicle door 16.

The cushion 12 includes a second panel 30 that has a primary surface 32, a secondary surface 34 and a peripheral edge 36 extending therebetween. The peripheral edge 36 has a primary side 38 and a secondary side 40 and the second panel 30 is elongated between the primary side 38 and the secondary side 40. The second panel 30 is positioned on the first panel 18 having the secondary surface 34 abutting the second surface 22. Moreover, the peripheral edge 36 is aligned with the perimeter edge 24. Stitching 42 extends through the first panel 18 and the second panel 30 and the stitching 42 is coextensive with the peripheral edge 36 and the perimeter edge 24. In this way the first panel 18 is coupled to the second panel 30.

A first strap 44 is coupled to and extends away from the first side 26 of the first panel 18. The first strap 44 has a distal end 46 with respect to the first panel 18 and the first strap 44 is selectively wrapped around a rear view mirror 48 of the vehicle. The distal end 46 is selectively matable to the first strap 44 such that the first strap 44 forms a closed loop. In this way the first strap 44 is retained around the rear view mirror 48 thereby inhibiting the cushion 12 from being removed from the vehicle door 16. A mating member, such as a hook and loop fastener, may be coupled to the first strap 44 for retaining the first strap 44 in the closed loop.

A second strap 49 is coupled to and extends away from the perimeter edge 24 of the first panel 18. The second strap 49 is centrally positioned between the first side 26 and the second side 28. Additionally, the second strap 49 has a distal end 50 with respect to the first panel 18. The second strap 49 is shut in the vehicle door 16 thereby inhibiting the cushion 12 from being removed from the vehicle door 16. A weight 51 is coupled to the distal end 50 of the second strap 49. The weight 51 inhibits the second strap 49 from being removed from the vehicle door 16 when the second strap 49 is shut in the vehicle door 16.

A plurality of magnets 52 is provided and each of the magnets 52 is positioned within the cushion 12. Each of the magnets 52 magnetically engages the outside surface 14 of the vehicle door 16 when the cushion 12 is positioned on the outside surface 14. Additionally, each of the magnets 52 is positioned between the first panel 18 and the second panel 30. The magnets 52 are spaced apart from each other and are distributed along the cushion 12. Stitching may extend around each of the magnets 52 to keep the magnets 52 stationary.

In use, the cushion 12 is positioned on the outside surface 14 of the vehicle door 16 when the vehicle is parked in a public parking area. The cushion 12 is horizontally oriented such that the cushion 12 extends along an entire length of the vehicle door 16. The second strap 49 is shut in the vehicle door 16 and the weight 51 inhibits the second strap 49 from being removed from the vehicle door 16. The first strap 44 is wrapped around the rear view mirror. The cushion 12 is removed from the vehicle door 16 when the vehicle is driven.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A dent protection assembly being configured to be selectively positioned on a car door thereby protecting the car door from dents resulting from contact with other car doors, said assembly comprising:
a cushion being configured to be positioned on an outside surface of a vehicle door, said cushion being comprised of a deformable material wherein said cushion is configured to inhibit the outside surface of the vehicle door from being dented, said cushion comprising a first panel having a first surface, a second surface and a perimeter edge extending therebetween, said perimeter edge having a first side and a second side, said first panel being elongated between said first side and said second side, said first surface being configured to abut the outside surface of the vehicle door;
a first strap being coupled to and extending away from said first side of said first panel, said first strap having a distal end with respect to said first panel, said first strap being configured to be selectively wrapped around a rear view mirror of the vehicle, said distal end being selectively matable to said first strap such that said first strap forms a closed loop wherein said first strap is configured to be retained around the rear view mirror thereby inhibiting said cushion from being removed from the vehicle door;
a second strap being coupled to and extending away from said perimeter edge of said first panel, said second strap being centrally positioned between said first side and said second side, said second strap having a distal end with respect to said first panel, said second strap being configured to be shut in the vehicle door thereby inhibiting said cushion from being removed from the vehicle door;
a weight being coupled to said distal end of said second strap wherein said weight is configured to inhibit said second strap from being removed from the vehicle door when said second strap is shut in the vehicle door, said weight having parallel planar opposite faces wherein said weight is flat; and
a plurality of magnets, each of said magnets being positioned within said cushion wherein each of said magnets is configured to magnetically engage the outside surface of the vehicle door when said cushion is positioned on the outside surface.

2. (canceled)

3. The assembly according to claim 1, further comprising a second panel having a primary surface, a secondary surface and a peripheral edge extending therebetween, said peripheral edge having a primary side and a secondary side, said second panel being elongated between said primary side and said secondary side, said second panel being positioned on said first panel having said secondary surface abutting said second surface, said peripheral edge being aligned with said perimeter edge.

4. The assembly according to claim 3, further comprising stitching extending through said first panel and said second panel, said stitching being coextensive with said peripheral edge and said perimeter edge.

5. (canceled)

6. (canceled)

7. (canceled)

8. The assembly according to claim 1, wherein each of said magnets is positioned between said first panel and said second panel, said magnets being spaced apart from each other and being distributed along said cushion.

9. A dent protection assembly being configured to be selectively positioned on a car door thereby protecting the car door from dents resulting from contact with other car doors, said assembly comprising:
a cushion being configured to be positioned on an outside surface of a vehicle door, said cushion being comprised of a deformable material wherein said cushion is configured to inhibit the outside surface of the vehicle door from being dented, said cushion comprising:
a first panel having a first surface, a second surface and a perimeter edge extending therebetween, said perimeter edge having a first side and a second side, said first panel being elongated between said first side and said second side, said first surface being configured to abut the outside surface of the vehicle door,
a second panel having a primary surface, a secondary surface and a peripheral edge extending therebetween, said peripheral edge having a primary side and a secondary side, said second panel being elongated between said primary side and said secondary side, said second panel being positioned on said first panel having said secondary surface abutting said second surface, said peripheral edge being aligned with said perimeter edge, and
stitching extending through said first panel and said second panel, said stitching being coextensive with said peripheral edge and said perimeter edge;
a first strap being coupled to and extending away from said first side of said first panel, said first strap having a distal end with respect to said first panel, said first strap being configured to be selectively wrapped around a rear view mirror of the vehicle, said distal end being selectively matable to said first strap such that said first strap forms a closed loop wherein said first strap is configured to be retained around the rear view mirror thereby inhibiting said cushion from being removed from the vehicle door;
a second strap being coupled to and extending away from said perimeter edge of said first panel, said second strap being centrally positioned between said first side and said second side, said second strap having a distal end with respect to said first panel, said second strap being configured to be shut in the vehicle door thereby inhibiting said cushion from being removed from the vehicle door,
a weight being coupled to said distal end of said second strap wherein said weight is configured to inhibit said second strap from being removed from the vehicle door when said second strap is shut in the vehicle door, said weight having parallel planar opposite faces wherein said weight is flat; and
a plurality of magnets, each of said magnets being positioned within said cushion wherein each of said magnets is configured to magnetically engage the outside surface of the vehicle door when said cushion is positioned on the outside surface, each of said magnets being positioned between said first panel and said second panel, said magnets being spaced apart from each other and being distributed along said cushion.
